(19) United States
(12) Patent Application Publication
(10) Pub. No.: US 2009/0310025 A1
(43) Pub. Date: Dec. 17, 2009

(54) Multiple channel modulator

(76) Inventors: Michael Anthony Pugel, Noblesville, IN (US); David Lowell McNeely, Indianapolis, IN (US); Dong-Chang Shiue, Carmel, IN (US); David Emery Virag, Noblesville, IN (US)

Correspondence Address: Robert D. Shedd, Patent Operations;THOMSON Licensing LLC, P.O. Box 5312, Princeton, NJ, 08543-5312, US

(21) Appl. No.: 11/919,100

(22) PCT Filed: May 3, 2006
(86) PCT No.: PCT/US2006/017058

§ 371 Date: Oct. 23, 2007

Related U.S. Application Data
(60) Provisional application No. 60/677,565, filed on May 4, 2005.

(51) Int. Cl. H04N 9/67

(52) U.S. Cl. 348/660; 348/E09.047

(57) ABSTRACT

The disclosed embodiments relate to a system and method for processing digital communication signals. An exemplary system comprises a first input adapted to receive a first digital communication signal, a second input adapted to receive a second digital communication signal, an upconverter adapted to generate a multichannel digital signal that incorporates data corresponding to the first digital signal at a first frequency and data corresponding to the second digital signal at a second frequency, and a digital-to-analog converter adapted to convert the multichannel digital signal to a multichannel analog signal.

### FIELD OF THE INVENTION

The present invention relates to processing communication signals such as digital transport streams. In particular, embodiments of the present invention involve the ability to process multiple digital transport streams in the digital domain.

### BACKGROUND OF THE INVENTION

This section is intended to introduce the reader to various aspects of art which may be related to various aspects of the present invention which are described and/or claimed below. This discussion is believed to be helpful in providing the reader with background information to facilitate a better understanding of the various aspects of the present invention. Accordingly, it should be understood that these statements are to be read in this light, and not as admissions of prior art.

The distribution of communication signals such as satellite or cable television signals presents a number of design challenges. Many situations involve the combining of information contained in multiple signals into a single radio frequency signal for broadcast. In some instances, each of the signals being combined represents multiple channels of information.

One example of a situation requiring the combination of multiple transport streams is the creation of a satellite television signal for broadcast. A transport stream may include multiple program streams of information, including digital video, digital audio, and data related to these streams or other information such as program guides. The incorporation of multiple transport streams into a signal allows different television receivers in a household receiving the signal to tune different programs without regard to whether the same program is being tuned by another receiver at the same location. Another situation in which the combination of multiple transport streams into a single signal is desirable is the distribution of cable television signals in a multiple dwelling unit (MDU) such as a hotel or an apartment building. Again, the use of multiple transport streams allows each user of the system to view any program without regard to whether the same program is being viewed by other users.

Typically, the signal source for each of the transport streams is connected to an individual modulator for generation of an individual analog radio frequency (RF) signal. Each of these signals is typically combined in analog circuitry. This approach necessitates costly duplication of circuitry as the number of transport streams being processed increases. A system and method that reduces the equipment requirement needed to process multiple transport streams is desirable.

### SUMMARY OF THE INVENTION

The disclosed embodiments relate to a system and method for processing digital signals. An exemplary system for processing signals comprises a first input adapted to receive a first digital communication signal, a second input adapted to receive a second digital communication signal, and an upconverter adapted to generate a multichannel digital signal that incorporates data corresponding to the first digital signal at a first frequency and data corresponding to the second digital signal at a second frequency. The exemplary system further comprises a digital-to-analog converter adapted to convert the multichannel digital signal to a multichannel analog signal.

An exemplary method comprises sampling a first digital communication signal and sampling a second digital communication signal. The exemplary method further comprises generating a multichannel digital signal that incorporates data corresponding to the first digital communication signal at a first frequency and data corresponding to the second digital communication signal at a second frequency, and converting the multichannel digital signal to a multichannel analog signal.

An alternative exemplary system comprises means (102) for generating a multichannel digital signal that incorporates data corresponding to a first digital communication signal (103a) at a first frequency and data corresponding to a second digital communication signal (103b) at a second frequency. The alternative exemplary system additionally comprises means (108) for converting the multichannel digital signal to a multichannel analog signal.

### BRIEF DESCRIPTION OF THE DRAWINGS

In the drawings:

FIG. 1 is a block diagram showing a multiple channel modulator in accordance with an exemplary embodiment of the present invention; and

FIG. 2 is a process flow diagram illustrating the operation of an exemplary embodiment of the present invention.

### DETAILED DESCRIPTION OF THE PREFERRED EMBODIMENT

This section is intended to introduce the reader to various aspects of art which may be related to various aspects of the present invention which are described and/or claimed below. This discussion is believed to be helpful in providing the reader with background information to facilitate a better understanding of the various aspects of the present invention. Accordingly, it should be understood that these statements are to be read in this light, and not as admissions of prior art.

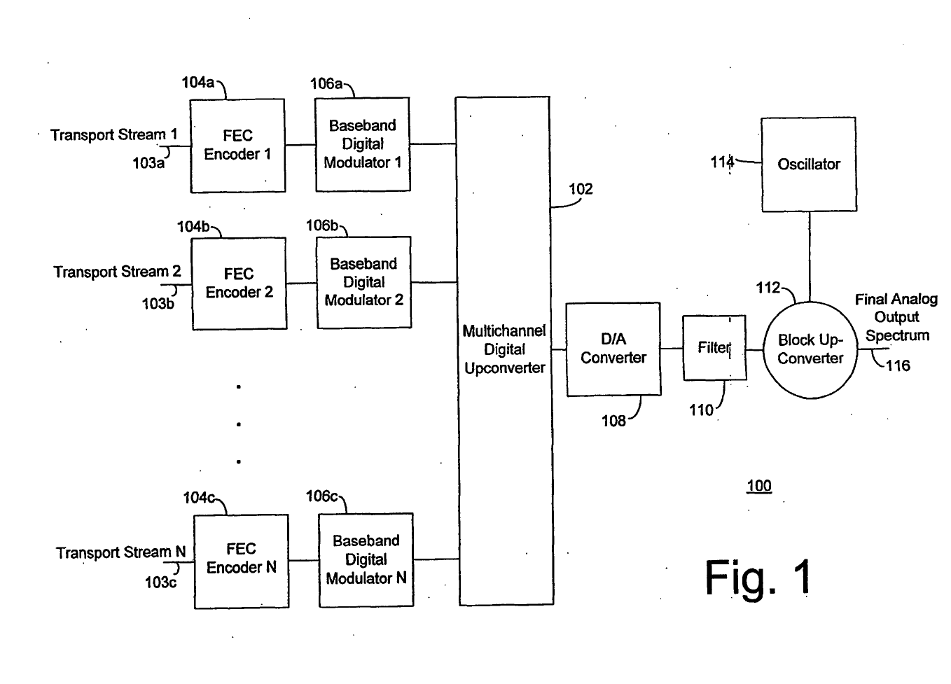

FIG. 1 is a block diagram showing a multiple channel modulator in accordance with an exemplary embodiment of the present invention. The multiple channel modulator is generally referred to by the reference number 100. The multiple channel modulator 100 is adapted to process a plurality of digital communication signals 103a, 103b and 103c, which may comprise digital video transport streams. In particular, an exemplary embodiment of the present invention is adapted to process a plurality of Moving Picture Expert Group (MPEG) digital video transport streams, each of which comprises a plurality of channels of audio and video information. Although the specific number of digital communication signals processed by the multiple channel modulator 100 is not an essential element of the invention, exemplary embodiments of the invention may process a relatively large number of digital video transport streams (e.g., greater than 16) simultaneously.

The digital communication signals 103a, 103b and 103c are respectively delivered to a plurality of forward error correction (FEC) encoders 104a, 104b and 104c. Each of the FEC encoders 104a, 104b and 104c is adapted to add error correction information to its respective one of the digital communication signals 103a, 103b and 103c. Any suitable error correction strategy may be employed by the FEC encoders 104a, 104b and 104c depending on system design considerations. Examples of error correction strategies that may be employed include Reed Solomon error correction encoding, Viterbi error correction encoding or the like.

Each of the outputs of the plurality of FEC encoders 104a, 104b and 104c is respectively delivered to a corresponding baseband modulator 106a, 106b, or 106c. The modulators 106a, 106b and 106c are adapted to form a modulated digital baseband (or near baseband) signal based on the received digital communication signal 103a, 103b or 103c. Any suitable modulation technique may be employed by the FEC encoders 104a, 104b and 104c depending on system design considerations. Examples of modulation techniques that may be employed include Quadrature Phase-Shift Keying (QPSK) modulation, Quadrature Amplitude Modulation (QAM) modulation or the like.

The modulators 106a, 106b and 106c are each delivered to a multichannel digital upconverter 102. The multichannel digital upconverter 102 creates a multichannel digital signal in the form of an upsampled, modulated and frequency shifted spectra containing data corresponding to each of the digital communication signals 103a, 103b and 103c. The data corresponding to each of the digital communication signals 103a, 103b and 103c are contained in separate channels in the digital frequency space. The data corresponding to the digital communication signal 103a is disposed as a first channel in the spectra at a first frequency. Similarly, the data corresponding to the digital communication signal 103b is located as a second channel in the upsampled spectra at a second frequency. Likewise, the data corresponding to the digital communication signal n 103c is disposed as an n^{th} channel in the output spectra at an n^{th} frequency.

The information can also be combined in a time domain representation comprising a plurality of samples from each of the channels. The upconversion operation can then be performed on this representation of the plurality of samples of the digital communication signals 103a, 103b, and 103c.

Those of ordinary skill in the art will appreciate that the upconversion operation performed by the multichannel digital upconverter 102 may be performed in a number of ways depending on the particular application. For example, the upconversion operation may comprise a polyphase rotation operation, an interpolation operation or the like.

The digital output of the multichannel digital upconverter 102 is delivered to a digital-to-analog (D/A) converter 108. The D/A converter 108 converts the digital input received from the multichanneled digital upconverter 102 into an analog signal. In the exemplary embodiment illustrated in FIG. 1, the analog output of the D/A converter 108 is delivered to a filter 110, which in turn delivers the output to a block up-converter 112. The block up-converter 112 adjusts the frequency of the analog signal to position the completed signal spectra in the correct spectral location for delivery to a satellite or onto a cable for distribution within an MDU. The resulting frequency of the output signal is determined by an oscillator 114, which is connected to the block up-converter 112. The output of the block up-converter 112 is a final analog output spectrum 116.

Exemplary embodiments of the present invention may allow significant reduction in hardware and clock rate. The implementation of the multichannel upconverter 102 allows processing of all of the datastreams in parallel, at a low clock rate, and may permit generation of the spectral output (combined channels in frequency) also maintained at a low clock rate until a point just before entering the D/A converter 108. Additionally, the combining of multiple digital communication signals into a multichannel digital signal in the digital domain requires relatively little integrated circuit real estate. This small footprint allows integration with multiple larger systems such as MPEG decoders, NTSC modulators, or the like. Additionally, the creation of the multichannel digital signal output of the multichannel digital upconverter 102 in the digital domain may result in a significant decrease in system hardware requirements compared to systems that combine transport streams in the analog domain. The same theoretical and engineering principles applied to corresponding blocks of an array of intermediate frequency (IF) modulators may allow the creation of efficient multi-modulators with similar desirable properties.

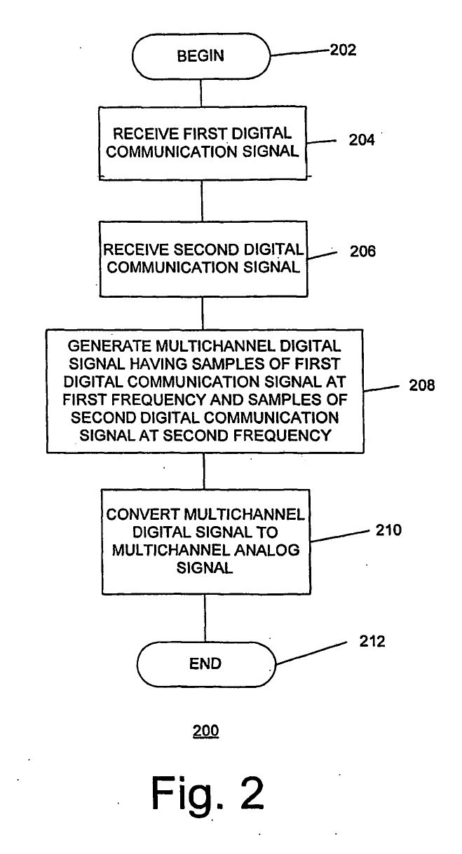

FIG. 2 is a process flow diagram illustrating the operation of an exemplary embodiment of the present invention.

The process is generally referred to by the reference number 200. At block 202, the process begins. At block 204, a first digital communication signal is received, for example, in the form of an MPEG digital video transport stream. At block 206, a second digital communication signal is received. The second digital communication signal may comprise a second MPEG digital video transport stream.

At block 108, a multichannel digital signal is generated from data corresponding to the first communication signal and data corresponding to the second communications signal. The multichannel digital signal comprises spectra in which data corresponding to the first digital communication signal is disposed at a first frequency and data corresponding to the second digital communication signal is disposed at a second frequency. Moreover, the data corresponding to the first and second digital communication signals are contained within the frequency spectra of the multichannel digital signal as separate channels.

At block 210 the multichannel digital signal is converted to a multichannel analog signal. At block 212, the process ends.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

1. A signal processing apparatus, comprising:
a first input adapted to receive a first digital communication signal;
a second input adapted to receive a second digital communication signal;
a combiner for generating a multichannel digital signal that incorporates data corresponding to the first digital signal and data corresponding to the second digital signal; and
an upconverter for converting the frequency of said multichannel digital signal to position the data corresponding to the first digital communication signal as a first channel at the first frequency in the multichannel digital signal and to position the data corresponding to the second digital communication signal as a second channel at the second frequency in the multichannel digital signal.

2. The signal processing apparatus recited in claim 1, wherein the first digital communication signal and the second digital communication signal comprise video data.

3. The signal processing apparatus recited in claim 1, wherein the first digital communication signal and the second digital communication signal each comprise a digital video transport stream.

4. The signal processing apparatus recited in claim 1, wherein the first digital communication signal and the second digital communication signal each comprise a Moving Picture Experts Group (MPEG) digital video transport stream.

5. The signal processing apparatus recited in claim 1, comprising:
a first forward error correction encoder adapted to provide error correction data for the first digital communication signal; and
a second forward error correction encoder adapted to provide error correction data for the second digital communication signal.

6. The signal processing apparatus recited in claim 1, comprising:
a first baseband digital modulator adapted to modulate the first digital communication signal before delivering the first digital communication signal to the upconverter; and
a second baseband digital modulator adapted to modulate the second digital communication signal before delivering the second digital communication signal to the upconverter.

7. The signal processing apparatus recited in claim 1, wherein the upconverter is adapted to perform a polyphase rotation operation on the first digital communication signal and the second digital communication signal.

8. The signal processing apparatus recited in claim 1, wherein the upconverter is adapted to perform an interpolated upconversion operation on the first digital communication signal and the second digital communication signal.

9. The signal processing apparatus recited in claim 1, comprising an analog upconverter adapted to adjust a frequency band of the multichannel analog signal.

10. A method of processing digital signals, comprising:
receiving a first digital communication signal;
receiving a second digital communication signal;
combining said first and second digital communication signals into a multichannel digital signal; and
upconverting said multichannel digital signal to position the data corresponding to the first digital communication signal as a first channel at the first frequency in the multichannel digital signal and to position the data corresponding to the second digital communication signal as a second channel at the second frequency in the multichannel digital signal.

11. The method recited in claim 10, wherein the first digital communication signal and the second digital communication signal comprise video data.

12. The method recited in claim 10, wherein the first digital communication signal and the second digital communication signal each comprise a digital video transport stream.

13. The method recited in claim 10, wherein the first digital communication signal and the second digital communication signal each comprise a Moving Picture Experts Group (MPEG) digital video transport stream.

14. The method recited in claim 10, comprising:
providing error correction data for the first digital communication signal; and
providing error correction data for the second digital communication signal.

15. The method recited in claim 10, comprising:
modulating the first digital communication signal before generating the multichannel digital signal; and
modulating the second digital communication signal before generating the multichannel digital signal.

16. The method recited in claim 10, comprising performing a polyphase rotation operation on the first digital communication signal and the second digital communication signal.

17. The method recited in claim 10, comprising performing an interpolated upconversion operation on the first digital communication signal and the second digital communication signal.

18. The method recited in claim 10, adjusting a frequency band of the multichannel analog signal.

19. A signal processing apparatus, comprising:
means for generating a multichannel digital signal that incorporates data corresponding to a first digital communication signal at a first frequency and data corresponding to a second digital communication signal at a second frequency; and
means for converting the multichannel digital signal to a multichannel analog signal.

20. The signal processing apparatus recited in claim 19, wherein the first digital communication signal and the second digital communication signal each comprise a Moving Picture Experts Group (MPEG) digital video transport stream.
